(19) United States
(12) Patent Application Publication
(10) Pub. No.: US 2010/0153457 A1
(43) Pub. Date: Jun. 17, 2010

(54) Gestural Interface Device and Method

(76) Inventor: Isaac W. Grant, La Jolla, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/638,969

(22) Filed: Dec. 15, 2009

Related U.S. Application Data
(60) Provisional application No. 61/122,679, filed on Dec. 15, 2008.

(51) Int. Cl. G06F 17/30; G06K 9/68

(52) U.S. Cl. 707/792; 382/218; 707/E17.055

(57) ABSTRACT

A method for eliciting a computer generated reaction based upon an electronic image of a field of view communicated to said computer. Based on communicated images of objects by users, actions are taken based upon a user's determined choice of an object in the field of view. Secondary actions may be provided by the user's designation of colored indicia or positioning of the object. Product designators engaged upon the object allow a service provider to provide specific actions related to the object chosen based upon a subscribers instructions associated with the chosen object bearing the designator.

This application claims priority to U.S. Provisional Patent Application No. 61/122,679 filed on Dec. 15, 2008 and is respectively incorporated herein in it's entirety by reference.

### FIELD OF THE INVENTION

The disclosed device relates to computer interfacing to initiate a response or action. More particularly it relates to a device and method of operation which allows for responses based upon visual computer recognition, of both objects and user actions, to initiate one or a plurality of preprogrammed responses to recognized items and concurrent or subsequent user physical actions.

### BACKGROUND OF THE INVENTION

Computer systems and networks in the last decade have advanced on a logarithmic scale. However, in spite of the advanced nature of computer processing and computer hardware, an interface between the user and computer is required to actually have the computer perform a specific action sought by the user.

Such computer systems that typically receive and process data are well known. Conventionally, such systems include a central processing unit (CPU), read only memory (ROM), random access memory (RAM), at least one bus interconnecting the CPU, the memory, and at least one input port or component to which a device is coupled for input commands, and output ports or devices from which the computer may transmit responses to user initiated requests.

Despite the great advance in computer processing and memory and broader band network communications to date, most computers still employ a video screen and mouse driven cursor to operate a graphic interface to execute and communicate commands for action to the computer. The graphic interface had been an advance over a pure text driven mode of input which required the user to type specific commands on the keyboard and subsequently input them to the computer. While still employed in many areas of computing, a keyboard and text interface minimizes the amount of users to those knowing the specific language and commands to type on a keyboard to elicit specific actions.

Such graphic interfaces which replace the text based interface do so by assigning pixel areas on a graphic depiction to represent an associated command to the computer. The user may employ a mouse, or trackball or joystick to cause a graphic cursor to move about a visual interface to the various command points, and then push an input button to execute the command.

However, computer interfaces for users still lag behind the ever advancing computer hardware and network transmission advances. This lack of more easily employable interfaces, which require little or no learning curve, in turn hinders the broader employment of computers and software to work upon more tasks for users. This is especially true for unsophisticated or new users who may not know how to operate the keyboard or how a visual interface operates to control computer functions.

A number of recent patents venture into the area of interfacing a human and computer to elicit an action or a response from the computer.

U.S. Pat. No. 7,205,979 (Zimmerman), recently allowed, teaches a device for generating control signals for the manipulation of virtual objects in a computer system according to the gestures and positions of an operator's hand or other body part. Zimmerman teaches the use of a glove worn on the hand of the user which includes sensors for detecting the gestures of the hand and hand position. The computer system includes circuitry connected to receive the gesture signals and the hand position signals for generating control signals in response thereto. However, Zimmerman is primarily concerned with using such hand gestures to operate a visual interface and requires complicated circuitry and a glove.

U.S. Pat. No. 7,307,661 (Lieberman) is another recent patent on the subject of computer interfacing. Lieberman discloses the use of an electronic imaging sensor and camera to output an imaged field to a computer. A second imaging sensor viewing the first image operates to execute commands based on the user's hand interrupting portions of the image from the first camera. Lieberman, however, requires two different imagers and in most modes some type of replacement keyboard that operates in place of the normal keyboard and is not a great advance on eliminating such devices or minimizing their requirement for use since it requires a keyboard and input by the user.

As such there exists a continued unmet need for a computer interface which minimizes the knowledge required of the user as to any command functions or visual interface actions to initiate computer actions. Such a device and method should allow for virtually any object itself to initiate an action once designated to a local or networked computer, without any need for a mouse, pointer, or keyboard or graphic interface. The object might be a three dimensional object or a page with indicia thereon, or a virtual object such as a pattern, or indicia forming a design upon a surface placed in the field of view of the component generating a digital image and communicating it to the engaged computer.

Such a device and method should therefor allow virtually any user to initiate an action by the computer, without a keyboard, a mouse, a trackball, or other input device, or any graphic or textual interface, by employing the object itself when viewed by a camera, as the input to the computer. Along with the object, other means for optional or sequentially initiated commands may be provided. For instance, the use of one or a combination of gestural components such as a finger or fingers, another object related or not to the first, a hand, a pointer, a color, object placement or proximity, finger placement, placement of the object itself in a predetermined position, or virtually any gestural interfacing which may be placed in memory and associated by the computer with one or a plurality of the digital images communicated from the field of view to the computer.

The field of view may be a small surface such as a desk, a room, or a large room such as a discount department store, a stadium, or a very large open area of land. In the field of view would be one or a plurality of cameras, or other means to generate a digital image. This image may then be communicated to a computer for interpretation and association with actions and the images in memory, be it a desktop with a webcam or a football field sized field of view with multiple imaging devices with telescopic zoom ability to find the objects and concurrent gestural motions to initiate the actions.

With respect to the above, before explaining at least one preferred embodiment of the invention in detail or in general, it is to be understood that the invention is not limited in its application to the details of construction and to the arrangement of the components or the steps set forth in the following description or illustrated in the drawings. The various apparatus and methods of the invention are capable of other embodiments, and of being practiced and carried out in various ways, all of which will be obvious to those skilled in the art once the information herein is reviewed. Also, it is to be understood that the phraseology and terminology employed herein are for the purpose of description and should not be regarded as limiting.

As such, those skilled in the art will appreciate that the conception upon which this disclosure is based may readily be utilized as a basis for designing new gestural interface systems for computer systems and the like, for carrying out the several purposes of the present disclosed device and method. It is important, therefore, that the embodiments, objects and claims herein, be regarded as including such equivalent construction and methodology insofar as they do not depart from the spirit and scope of the present invention.

### SUMMARY OF THE INVENTION

Computer interfaces whether graphic or text based, generally require a working knowledge of the user on how the interface commands the computer to actually execute functions. Textual interfaces require typed commands, which must be learned and input. Graphic interfaces require a user moved device to initiate cursor movement to various points on the screen and a subsequent input device, such as a mouse button, to indicate to the computer that the cursor is interfaced on the screen properly to execute the command associated with the pixel location. As one can see, both interfaces require a prior knowledge of their operation, or a learning curve for a user to ascertain their operation to actually get the computer to execute a function.

The present invention contemplates a novel method and device that employs one or preferably a plurality of video cameras or other means to generate a digital image of the field of view in which objects, or gestural movements, or both are situated and in view. The field of view is any area which may be imaged by a device adapted to generate and communicate a digital image of part or all of that area as a field of view to a computer. This can be at a home or private residence, or a business or public place.

The viewing area may be as small as a desktop or might be an entire room, or a home or residence, which is viewable by the cameras in a static position or rotatable position. It might be multiple rooms in a building so long as imaging devices have a view of the areas. Or, the area might be a large warehouse department store or a stadium or any other area where one or a plurality of imaging devices may capture all or a portion of the area in a field of view which may be digitally communicated to a computer for interpretation and relation to stored images and actions.

In operation, at least one camera transmits a digital image which is preferably in color, but might also be infrared, or black and white, or combinations thereof and other spectrums, to a computer. This is done either remotely over a network or to a computer proximate to the camera or imaging devices, or both. Upon receipt of the digital image of the imaged field of view or portion thereof, the computer employs image recognition software to ascertain the presence of one or a plurality of objects which are located in the discerned field of view of the camera or imaging device. Specifically, an object or objects are in some fashion, designated gesturally, by the user in the field of view, as the chosen object for which the computer is to execute an action which relates to that object. The gestural designation might be a holding or a touching of the device or object for a defined period of time where the transmitted field of view would yield frame patterns in the field of view which are essentially the identical for a defined period. The computer would ascertain this non changing pattern, over time, as a choice by the user.

A user-choosing of the object in question can be designated by simply touching the object or placing the object in a predetermined position in the field of view of the camera or cameras or touching the object and touching a designated point in the field of view. Other gestural motions might be employed such as one finger, two fingers, hand signals, using another object or pointer or light or anything that the computer will discern is the gestural component. The computer or computers communicating with the imaging-component generated image transmission employ software adapted to monitor objects and gestural actions discerned in its field of view and thereafter employs the objects themselves as the cue to initiate an action related thereto. As noted, the objects may be three dimensional objects, renditions thereof in scale, indicia on a flat or non flat surface, depictions on a surface such as paper, or indicia in the form of abstract or non abstract images, or virtually any two dimensional or three dimensional object or image that may be digitally captured by an imaging component from the field of view and transmitted to the computer engaged with the memorized objects and actions and relations thereto.

As also noted, the camera or imaging device can be any device capable of capturing and digitizing an image of the field of view or portion thereof and communicating it electronically to a computer adapted with software to initiate actions based on the digital image and/or any concurrent gestural action of the user which might yield an additional action or subset action related to the object.

In use, once an object choice, is communicated by the user action, the camera or cameras or other imaging devices capable of generating a digital image, communicate one or a plurality of video images of the object chosen, to the local or networked computer communicating with the camera. If more than one camera is employed for the field of view, than a plurality of views of the object, from different angles, would be communicated. Software adapted to the task, compares the transmitted image or images of the object designated by the user as the chosen object to a stored database of digital images previously placed in an electronic memory operatively engaged to the computer doing the comparison.

Using one, or the plurality of angled views of the chosen object, software will make a comparison and match of the communicated view and objects to stored images in the database. Each such individual or set of images of objects stored in memory is pre-associated by the software with one or a plurality of actions which the software executes once a match, between the user-chosen object is ascertained, with that of an image stored image in memory. Of course the computer can be continually ascertaining which objects are in the field of view such that, when a user designates one as chosen, the lookup action is not necessary since the computer already knows the object and needs only to ascertain the action the user's choosing of that object initiates.

As a consequence of using the object itself to initiate the action related to that object or not related to it, no mouse or keyboard input or graphic or textual interface input is required to initiate a computer action. Hence, there is no learning curve for the user wanting information or relational data associated with an object, other than to touch or otherwise designate it. Additional options for computer action can be made available to the user by placing instructions adjacent to the camera or the objects which instruct the user where to place the object to indicate one or a plurality of choices of computer response based on the placement or how to touch the object to indicate in the view of the camera that the user chooses the object to the computer monitoring the video feed from the camera.

For instance, in a hardware store the user seeking more information such as price and how to use a wrench might touch or place a wrench in a designated position in the field of view. Software adapted to the task will determine the touch or movement to the position in the field of view and determine a choice of an object has occurred. The user might use one finger for one type of information and two fingers for other information. Or, the user might designate the wrench by touching it with another object such as a bolt. The computer discerning the images of both items can provide information on each or information on how the wrench and bolt relate and perform with each other. Thus, fingers need not be the only gestural designator, other objects may be such as a pointer, or pen, and the like, or an object related to the first object if information is desired about both. Bringing two or more identifiable objects together in the scene of a connected camera is also considered an independent gesture recognizable by itself by the computer, and may be used to trigger one or more computer commands related to a combination of the objects brought together.

### Example #1

A wrench on the shelf in a store is a recognizable object. A card like a credit card, a driver's license or a retailer card is a second recognizable object. When the user touches the wrench with his card this may trigger a computer action like sending information to the email on file associated with the given card, or mail a catalog to the mailing address on file associated with the given card.

### Example #2

A wrench on the shelf in a store is a recognizable object. A human right hand is a second recognizable object. When the user touches the object with his right hand the computer reads it as a gesture to trigger a computer command or a series of commands, for example starting a video or audio clip on a computer-connected screen near by the user.

If the computer has not already ascertained the object prior to designation, the software will then take the image or images of the object from different angles, and compare them to a library of objects stored in memory to ascertain a match of one or a plurality of stored images in memory. Ascertaining a match to a stored digital image can be by comparison of images stored at one angle if one camera is used, or from two angles if two cameras or more are used.

Video recognition software, by analyzing and comparing frame/image sequence, identifying patterns and changing the sequence of images or by using any other image processing, combined with pattern algorithms, may employ an outline recognition of the object by ascertaining points around the perimeter to yield a digital fingerprint of the object or may employ color to ascertain what it is not, first, and then from the remainder of stored object images in memory, ascertain what the image matches. Or pixels of the area the object occupies in the field of view may be employed to ascertain a digital shape or fingerprint for comparison to that of images stored of objects in memory. Or other means for software to ascertain a match between the object designated, and a digital image or images of the object pre-stored in a lookup memory or other database adapted to the task of comparing visual characteristics of the designated object to characteristics of images of the object in memory.

In the example at hand, once a match is determined between the wrench chosen and a digital image or images of the wrench stored in connected electronic memory, the software will then associate one or a plurality of predetermined actions to take, which have been associated with the stored image of the wrench.

In this example, the user might choose a first wrench by touching it more than once or once for a duration of time which is programmed to designate a choice or by moving it to a designated spot in the field of view. The video image is transmitted of the first wrench to the computer which ascertains a match with an image in connected electronic memory. Software running on the computer then executes an action which in this case can be sending a video image or show to a screen adjacent to the camera in the room with the user which shows how the wrench works.

The same user may at this point pick up a competing product in the form of a second wrench and touch it or place it in a predesignated position in front of a camera, such as a drawing of a box, for a duration of time the computer is programmed to determine in the choosing of the second wrench. The camera then transmits the image of the second wrench to the computer running the image comparison and matching software which ascertains a match between the second wrench and a stored image. Video or printable information would then be transmitted back to the video screen near the object or the user such as a video on how the second wrench works.

Thus, the user need only know they must touch an object or place it in a designated spot in front of one or a plurality of cameras to execute a command to provide them information on or related to the chosen object.

In another example, the user might be a child and the objects a plurality of plush toys resembling animals. The child need simply touch one of the toy animals or place it in a designated spot in front of the cameras to designate a choice.

The computer, running the image matching software or perhaps motion sensing software which would sense motion of the object and then a stationary positioning, would then ascertain that a match existed with a stored image and then initiate an action related to the chosen object. In this case, if the child chooses a toy lion, the computer might send a video program all about lions with video and audio to the video display adjacent to the child and they may watch. Or, the transmitted information might be pricing on the toy, or a video of how the toy operates so the child can try it out in the store.

As can be seen, the only thing the child user or even an adult user need know is how to touch or move the object, or where to place the object in front of a camera.

The system may be extended to entire rooms or stores if sufficient cameras and connections can be placed to view the room. In such cases the user might simply move the object in question for a short period of time in front of a camera or cameras where it is tracked and ascertained as an object. The user simply stopping movement for a short duration of time would communicate a choice and the camera or cameras would send a snapshot of the object to the computer running the video matching software to do a lookup for a digital picture of the object in memory. In this mode of the device and method, the objects would best be stored in a 360 degree image such that no matter at what angle the user holds a chosen object in front of the camera, a digital image from that object can be ascertained by electronically rotating the digital image in memory to ascertain a match with the object designated and held in front of the camera by the user at an angle.

In another preferred mode of the device, a different user action designation component may be added. In a particularly preferred mode, the user action choice would employ colored indicia placed in a spot in the field of view of the camera such as colored dots or squares on a flat surface such as a piece of paper or plastic or thimbles or colored covers to the fingers or colored sticks might be employed for designation of and ascertaining colored indicia points. The colored indicia points will have user instructions associated with them either adjacent to them or by instructions given the user in another fashion.

Using the colored indicia designators, the user holding up the aforementioned wrench, once chosen, might touch one colored dot for a first type of information from the computer or a second or third colored dot to receive other information. If the user wishes pricing information they might touch a green dot, and if they wish operational information on the wrench they might touch a blue dot. If they wish comparison to other products they might touch a yellow dot.

In operation using choice indicia, when the video image from the camera of the chosen wrench is ascertained as a match by the monitoring computer, the software adapted to the task would then be programmed to monitor the video received from a camera for a color of indicia being touched or pointed to by the user. A touch can be ascertained, for instance, by the user's finger blocking the colored indicia from camera view which would be ascertained as a choice. Once the chosen indicia color is determined in the second step, information associated with the wrench and the user color choice would be communicated to the user via video, audio, or by causing a printer to print information for the user, or any combination of any computer commands.

As can be seen from the above examples, all a user need know is to touch or move an object which can be three dimensional or two dimensional and depicted on a surface within the field of view in front of one or a plurality of cameras to initiate computer action based on their choice of the object and preferably related to that object. No operating system knowledge nor text or graphic interface knowledge is needed by the user to obtain information related to the object chosen or associated with the object chosen.

In yet another particularly preferred mode of the device and method herein, a service provider might provide a logo or other indicia signification that a certain object is the means to initiate action by a computer, for example, to provide information to the user about that object. In this mode of the device, a logo or sticker might be engaged upon a surface of the object of interest which would have two purposes. First, it would designate to users that the object itself can be the interface with a computer to provide information or an action associated with that object. Second, to a computer monitoring within a field of view a siting of the logo in a transmitted image would initiate the computer to start a process relating to the object to which the logo is attached.

For instance, at a delicatessen, two dimensional images, or plastic or real sandwiches might have a logo sticker placed upon them indicating the object is camera-enabling. The logo or symbol would be advertised, or otherwise made known, that if affixed to an object that object will cause a computerized action if designated as chosen by a user. In this case, the user picking up a ham and cheese sandwich and holding it in front of the camera in a manner to show a choice could order the sandwich. Optionally, they could touch a yellow dot in view of the camera to order mustard, and a white dot to order mayonnaise on the chosen sandwich. The order would be entered and the sandwich custom produced.

In another example the symbol that an object is camera-enabling might be placed on the wrench noted above at a hardware store. The user seeing the symbol, would know that signifying a choice of that wrench, in view of a vendor provided camera, will gain them the desired information on operation, price, or other information they might wish.

Or, the logo or symbol designator may be broadened to provide information on just about any object that is pre-imaged and stored and digitally stored in memory accessible by the computer. In such a system, the provider would issue an object designator image, which, when coming into the field of view of any camera communicating with a computer having software adapted to ascertain the presence of an object designator, would initiate a second action by the computer to ascertain the object itself, based on images sent from the camera of the field of view. Once so ascertained, an action would occur relating to the object.

For instance, a user receiving an order for a stapler from a supplier would see that the object designator symbol was on the stapler. In this case the object designator would be a logo on a sticker. The user, having been pre-educated to the fact by advertising or reading material, would recognize that the symbol would initiate an action relating to the object. In a next step, using the internet, the user would go to a website for the shipper adapted to receive images from the user's webcam. Once there, the user would hold the object in the field of view, and the computer receiving the object would recognize the symbol or logo which would initiate the computer to then recognize the object itself, and subsequently give the user information about the object or a menu of choices related to the object from which the user may designate actions.

In the example at hand, once the remote computer ascertains it is the stapler being held in the field of view, after recognizing the object designator, the computer might provide warranty information, supply information, or other information about the object.

This object-designator method and service, can be employed on just about any object which can be placed in the viewing area of a camera which does or can communicate with a computer which would receive images from the viewing area. In this mode, the computer would first ascertain the location of the object designator, which in this case would be a logo sticker, and then ascertain the object itself from stored images thereof. Subsequent to the second step, one or a plurality of actions would ensue by the computer based upon recognition of the object and the logo or object designator detected. Of course, a plurality of object designators might be provided for one object which would elicit different responses based on the one chosen or communicated over the camera image to the computer.

The foregoing has outlined rather broadly the more pertinent and important features of the device and method herein employing objects to initiate computer actions in order that the detailed description of the invention that follows may be better understood so that the present contribution to the art may be more fully appreciated. Additional features of the invention will be described hereinafter which form the subject of the claims of the invention. It should be appreciated by those skilled in the art that the conception and the disclosed specific embodiment may be readily utilized as a basis for modifying or designing other object oriented systems and methods for carrying out the same purposes of the present invention. It should also be realized by those skilled in the art that such equivalent constructions and methods do not depart from the spirit and scope of the invention as set forth in the appended claims.

In this respect, before explaining at least one embodiment of the invention in detail, it is to be understood that the invention is not limited in its application to the details of construction and to the arrangement of the components set forth in the following description or illustrated in the drawings. The invention is capable of being a method, a system, other of embodiments and of being practiced and carried out in various ways. Also, it is to be understood that the phraseology and terminology employed herein are for the purpose of description and should not be regarded as limiting.

### THE OBJECTS OF THE INVENTION

It is therefore an object of the present invention to provide a computer interface to initiate actions by a computer running software adapted to the task which employs objects as an action choice designator for a user.

It is another object of this invention to provide multiple choices by a user based on designation of an object in front of a camera or digital imaging device and employing colored indicia in a position or on a pointer or finger, subsequent to designating the object.

It is another object of this invention to provide a method of communicating information or products to users based on transmitted digital images of objects and indicia by the user within the frame of view of the camera.

It is yet another object of this invention to provide a means to initiate a computer action based on transmitted images of an object or objects which are three dimensional or two dimensional depictions where the object bears a logo or object identifier which initiates the action based on its presence in the field of view.

It is still another object of this invention to provide a computer and user interface which requires virtually no operating system knowledge by the user other than they must touch or otherwise designated an object in camera view to initiate an action.

Yet another object of this invention is the provision of a business service to subscribers which employs objects located remotely to ascertain user choices and to initiate actions on behalf of the subscriber, based on the user designations.

The foregoing has outlined some of the more pertinent objects of the invention. These objects should be construed to be merely illustrative of some of the more prominent features and applications of the intended invention. Many other beneficial results can be attained by applying the disclosed method and device in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF DESCRIPTION OF THE DRAWINGS

The accompanying drawings, which are incorporated in and form a part of this specification, illustrate embodiments of the invention and together with the detailed description, serve to explain the principles of this invention.

FIG. 1 depicts a simple box diagram of the system and method wherein an object initiates an action on a computer which relates to the object designated in a camera field of view.

FIG. 2 depicts the device and method of FIG. 1 when employed with a provider-distributed object designator, such as a sticker or logo to be attached to the pre-imaged object which triggers action when in the field of view of the computer connected camera.

### DETAILED DESCRIPTION OF THE PREFERRED EMBODIMENTS

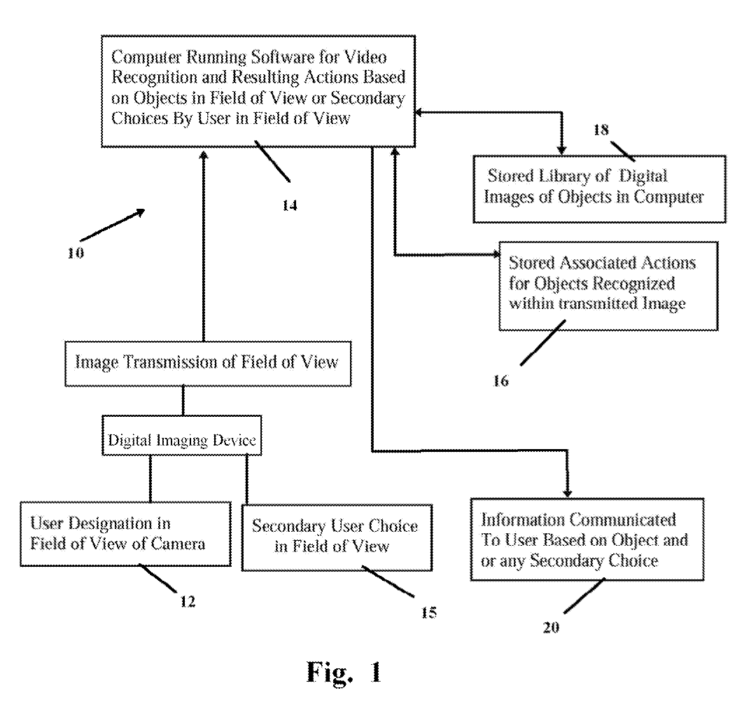

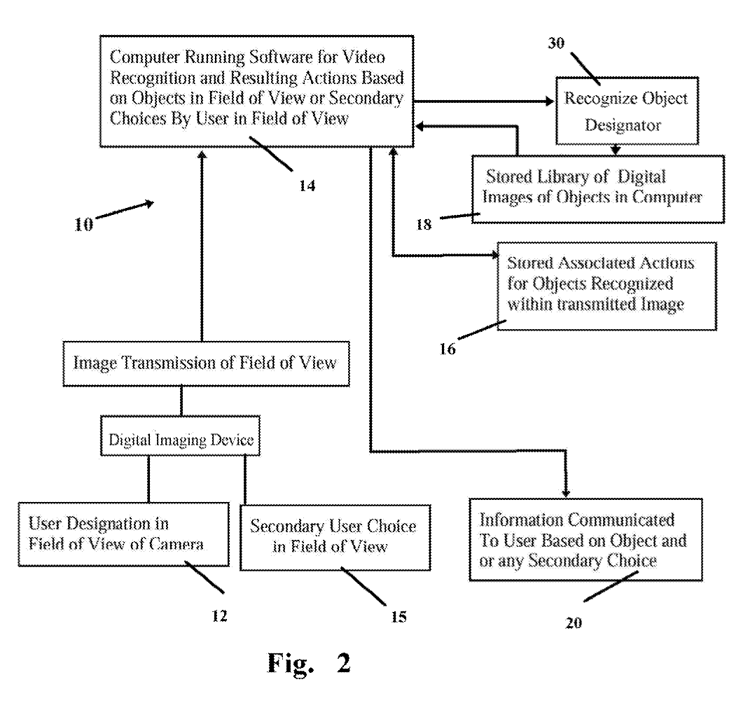

Referring now to the drawings, wherein similar parts of the invention are identified by like reference numerals, there is seen in FIGS. 1 and 2, the device 10 and method herein disclosed wherein an object placed in the field of view 12 acts as the action designation input to a computer 14 to elicit further action 16 relating to the object itself, by the computer recognizing the object 18 when communicated and compared to a database of pre-stored images of the object.

As described in the various methods of operation above, the user placing the object in a predetermined area or touching it for a duration of time or holding it for a duration of time, or viewing it for a duration of time, provides the input 14 by a placement within or touching or holding in the field of view of the imaging device communicating with a computer.

The computer, running software adapted to the task and using rules related to one or a combination of user-positioning of the object in a designated spot or spots, user-touching or user-holding for a time duration, or user-staring for a time duration, would ascertain an object choice. This would be done through employment of software to first recognize the object from a lookup of images stored in the database 18, and then ascertaining if it was touched, place, stared at, or otherwise designated per the rules of user-designation of choice.

Once a choice and a match to stored object image is ascertained, an action will be taken based on the choice of the object. This action may be information 20 returned to the user or some other action taken which is related to the stored object image based on the object perceived as user-chosen by a placement in the field of view in a position, a touching, or other means for user choice.

Optionally, a secondary user choice 15 may also be placed in the field of view for a subset of actions or additional information relating to the chosen object ascertained by the computer software as noted above.

In FIG. 2, there is shown another preferred mode of the invention wherein the method herein is employed as a business service by a service provider. The service provider would be hired by subscribers to the service and would provide the aforementioned computer and object recognition and may also provide attachable object designators 30 for the objects.

In this mode of the method herein, the service provider would provide subscribers with designators 20 which can be a logo, a bar code, or some other visually-identifiable image, which when positioned in the field of view of the imaging device communicating with the computer as noted above, would be recognized. Once the designator 20 is recognized, this would elicit an action from the software running on the computer, in a next step, to then ascertain the identity of the object bearing the object designator 20 which was placed in the field of view by the user. Once the designator 20 recognition initiates the system to identify the object bearing the designator 20 by a comparison to digital photos of the object, if there is a match to a stored image of the object bearing the designator 20, the software running on the computer would provide information to the user, or take other actions stored as related actions to take upon recognition of the object placed in the field of view. The initial step in this service would therefor be to first ascertain if a designator 20 is in the field of view. If recognized as an object bearing an object identifier 20 issued by the service provider, then actions provided to the provider, by the subscriber, and related to the object, would be taken.

For either mode of the method, the user may optionally also request a secondary choice or action by taking a user secondary action in the field of view, in combination with the recognizable object. This secondary action can be a user touching of colored indicia or the like, or placement in a predetermined position in front of the imaging device communicating with the computer running the software adapted to the secondary task. The colored indicia may be dots on the object itself, or in the field of camera view. The plurality of dots or colored indica would initiate a computer action based on which of the plurality is chosen by a touching by the user in the field of view. In the case of position designation, squares or circles or other designated positions in the field of view would initiate the secondary action if the user placed the object on, or in, the position. In this manner, the user may designate that an action be initialized by choosing an object. The action stored as related to the object recognized would then be taken. Secondary actions may also be elicited by the user based on a plurality of areas of colored indicia or placement of the object chosen in one or a plurality of designated positions. Touching a specific color, positioning the chosen object in one of a plurality of possible positions or placing it within the field of view will thereby allow the user to employ the object for secondary actions as well as the primary action stored as related to the recognized object.

As a service, the computer running both the object recognition and association software and the secondary choice software could be networked to the subscribers home or business. Customers picking objects in the field of view or designating secondary actions would be provided with those actions by the service provider based on a table of actions provided by the subscriber and related to the designation of an object, and the user's secondary designation. In a service provider type employment of the method herein, the object designators 20 would allow multiple service providers to operate viewing objects in the same field of view but only take actions when their own designator 20 is recognized. Or, a single provider might issue multiple designators 20, each of which is related to a manufacturer or other party wishing to provide actions or information if an object is user chosen. In that case the service provider would recognize which designator 20 is on the object discerned as chosen by a user, and then take the actions related to the object choice which are provided by the subscriber related to the individual respective designator 20.

While all of the fundamental characteristics and features of the disclosed device have been described herein, with reference to particular embodiments thereof, a latitude of modification, various changes and substitutions are intended in the foregoing disclosure and it will be apparent that in some instances, some features of the invention will be employed without the corresponding use of other features without departing from the scope of the invention as set forth. It should be understood that such substitutions, modifications, and variations may be made by those skilled in the art without departing from the spirit or scope of the invention. Consequently, all such modifications and variations are included within the scope of the invention as defined herein.

Further, the purpose of the herein disclosed abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A method for eliciting a computer generated reaction, comprising:
defining a field of view for an image outputting electronic images of said field of view;
communicating said field of view to a computer running object recognition software;
ascertaining if a user has touched or otherwise executed a choice of an object in said field of view;
if said choice is ascertained, transmitting an electronic image of said object to a computer;
employing said object recognition software to ascertain if said electronic image said object chosen by said user is a match for any of a plurality of images stored in an electronic data base; and
if a said match is ascertained, executing an action stored in said database related to said match.

2. The method of claim 1 additionally including:
issuing object designators by a service provider;
after ascertaining if a user has touched or otherwise executed a choice of an object in said field of view, then ascertaining if a said electronic image of said object also bears said object designator;
if said object designator determined in said field of view and upon said object, continuing the remaining steps of claim 1.

3. The method of claim 2 additionally including:
associating individual said object designators, from a plurality of said object designators, with a subscriber;
ascertaining which said subscriber said object designator, if ascertained as present in said field of view, is associated with; and
executing said action based on provided actions to be associated with said object, by said subscriber associates with said object designator.

4. The method of claim 1 additionally including:
allowing said user to designate a secondary said action be taken, based on said user positioning said object in one of a plurality of positions in said field of view.

5. The method of claim 2 additionally including:
allowing said user to designate a secondary said action be taken, based on said user positioning said object in one of a plurality of positions in said field of view.

6. The method of claim 3 additionally including:
allowing said user to designate a secondary said action be taken, based on said user positioning said object in one of a plurality of positions in said field of view.

7. The method of claim 1 additionally including:
allowing said user to designate a secondary said action be taken, based on said user choosing one colored indica from a plurality of colored indica in said field of view.

8. The method of claim 2 additionally including:
allowing said user to designate a secondary said action be taken, based on said user choosing one colored indica from a plurality of colored indica in said field of view.

9. The method of claim 3 additionally including:
allowing said user to designate a secondary said action be taken, based on said user choosing one colored indica from a plurality of colored indica in said field of view.
